(19) United States
(12) Patent Application Publication
(10) Pub. No.: US 2005/0163309 A1
(43) Pub. Date: Jul. 28, 2005

(54) Apparatus of power line communication in portable device

(75) Inventor: Seo Kwang Kim, Incheon-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/009,069

(22) Filed: Dec. 13, 2004

(30) Foreign Application Priority Data
Jan. 20, 2004 (KR) 4066/2004

(51) Int. Cl. H04B 1/16; H04M 1/00

(52) U.S. Cl. 379/413; 455/343.1

(57) ABSTRACT

The present invention relates to an apparatus and method for sharing a power line and a data communication line between a master and a slave in a portable unit. The apparatus for sharing a power line and a data communication line in a portable terminal is configured to supply a charge power of a battery to a terminal body and can include a battery communication unit that supplies a battery data through a single power line through which a discharge power is supplied to the body and receives a communication data from the body; and a body communication unit that transmits a communication data to the battery communication unit through the single power line and receives the battery data from the battery communication unit.

### BACKGROUND OF THE INVENTION

1. Field of the Invention

The present invention relates to an apparatus and method for sharing a signal line between a master and a slave.

2. Background of the Related Art

FIG. 1 is a diagram illustrating power lines and data communication lines between a related art portable terminal and a battery. As shown in FIG. 1, a communication line between a battery unit 10 and a terminal body 20 includes a power line “a” that supplies a power Vcc of a battery to the terminal body 20, a first communication line “b” that that transfers a serial clock signal (SCL) for a synchronization between the battery unit 10 and the terminal body 20 based on an I2C (Inter IC) protocol, and a second communication line “c” that transfers a serial data signal (SDA) and a ground line “d”.

FIG. 2 is a diagram illustrating a communication protocol between a battery and a terminal body in a related art portable terminal. As shown in FIG. 2, an I2C protocol is generally used as a communication protocol for a bi-directional communication between the battery unit and the terminal body.

A related art operation will be described with reference to FIGS. 1 and 2. In a related art portable terminal, it is needed to transfer a battery data such as a battery installation state, a capacity check of a battery, and a charged or discharged state of a battery to a user through a display unit (e.g., display unit 21 of FIG. 1) of the terminal body 20. The battery data are bi-directionally communicated between the portable terminal and the battery based on a certain communication protocol (e.g., I2C protocol), so that a user can obtain a desired battery data.

The communication protocol is formed of a serial clock signal (SCL) and a serial data signal (SDA). The data communication is performed at various data rates. In the standard mode, a data communication is performed at 100 Kbps. In the fast mode, data communication is performed at 400 Kbps, and in the high speed mode, it is performed at 3.4 Mbps.

As shown in FIG. 2, a communication starts at the time when a signal level of a serial clock signal SCL transferred through the first communication line “b” of FIG. 1 is high, and a signal level of a serial data signal SDA transferred through the second communication line “c” is low. A level conversion of a data is performed when the level of a serial clock signal is low, and a valid data is transferred when the level of the serial clock signal is high, and the second communication line “c” is stable.

However, as described above, the related art has various disadvantages. In the related art portable terminal, there are provided two contact points between the battery unit 10 and the terminal body 20 because a serial clock signal line (e.g., first communication line) and a data signal line (e.g., second communication line) are respectively connected. Accordingly, a short circuit problem may occur because of an interference between signals at a plurality of signal line contact points and use (e.g., long time use) of the system.

The above references are incorporated by reference herein where appropriate for appropriate teachings of additional or alternative details, features and/or technical background.

### SUMMARY OF THE INVENTION

An object of the invention is to solve at least the above problems and/or disadvantages or to provide at least the advantages described hereafter.

Another object of the present invention is to provide an apparatus and method for sharing a power line and a data communication line between a master and a slave that solves at least the related art problems and/or disadvantages or provides at least the advantages described hereafter.

Another object of the present invention is to provide an apparatus and method for sharing a power line and a data communication line capable of achieving a data communication using a power supply line between a terminal body and a battery of a portable terminal.

Another object of the present invention is to provide an apparatus and method for sharing a power line and a data communication line capable of providing a novel circuit structure that is designed to separate power and data.

Another object of the present invention is to provide an apparatus and method for sharing a power line and a data communication line that are implemented based on a novel control method for a data transmission and receiving operation.

Another object of the present invention is to provide a data communication through a power line without using a signal line used for a communication between a battery and a body.

Another object of the present invention, is to provide a connection terminal installed for a signal line between a battery and a body to reduce or prevent interference between signal lines or a malfunction because of a short circuit/disconnection.

To achieve at least the above objects in a whole or in part, there is provided an apparatus that includes a battery communication unit configured to supply a battery data and power through a power line to a portable terminal body and receive communication data from the terminal body through the power line and a body communication unit configured to transmit the communication data to the battery communication unit and receive the battery data from the battery communication unit through the power line.

To further achieve at least the above objects in a whole or in part, there is provided a method for supplying power to a portable terminal that includes providing a power line through which battery power is coupled to the portable terminal, transmitting a battery data to the portable terminal through the power line and transmitting communication data from the portable terminal through the power line.

To further achieve at least the above objects in a whole or in part, there is provided a method for using a communication line to transfer power and data communications between a battery and a terminal body that includes providing a communication line for coupling a battery and a portable terminal body and transmitting a battery data and power through the communication line.

To further achieve at least the above objects in a whole or in part, there is provided a method for using a communication line to transfer power and data communications between a battery and a terminal body that includes providing a communication line for connection between a battery and a portable terminal body and transmitting terminal communication data and power through the communication line.

To further achieve at least the above objects in a whole or in part, there is provided an apparatus for sharing a power and data communication line in a portable terminal that is configured to supply a charge power of a battery to a terminal body, the apparatus including battery communication device for supplying battery data through a single power line through which a discharge power is supplied to the terminal body and for receiving a communication data from the terminal body through the power line and body communication device for transmitting the communication data to the battery communication device through the single power line and for receiving the battery data from the battery communication device through the power line.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a diagram illustrating a power line and a communication line between a body and a battery of a related art portable terminal;

FIG. 2 is a diagram of a communication protocol between a battery and a body in a related art portable terminal;

FIG. 3A is a diagram illustrating a power supply line that supplies a battery power to a terminal body in a preferred embodiment according to the invention;

FIG. 3B is a diagram illustrating a data communication line that transfers data from a battery unit to a terminal body in a preferred embodiment according to the invention;

FIG. 3C is a diagram illustrating a data communication line that transfers data from a terminal body to a battery unit in a preferred embodiment according to the invention;

FIG. 4A is a diagram of an exemplary waveform representing Vcc+5V for a Vcc battery power supplied to a body through a power line and a data communication between a body and a battery;

FIG. 4B is a diagram showing an exemplary communication protocol adapted to a power line communication apparatus according to a preferred embodiment of the present invention;

FIG. 5A is a diagram showing a data format for a data transmission and receiving between a master of a body and a slave of a battery unit according to an embodiment of the present invention;

FIG. 5B is a flow chart showing an exemplary data transmission and receiving procedure based on the communication packet of FIG. 5A; and

FIG. 6 is a flow chart showing an embodiment of a data transmission and receiving procedure between a master of a body and a slave of a battery unit according to the present invention.

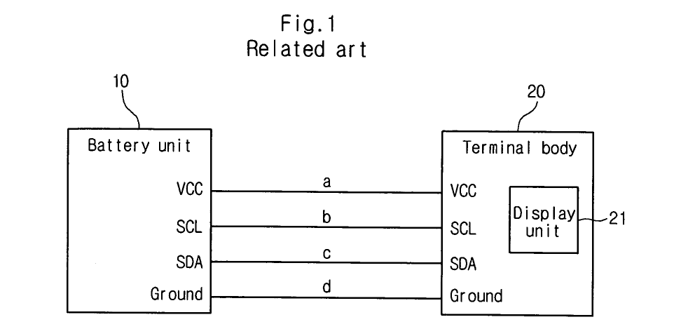

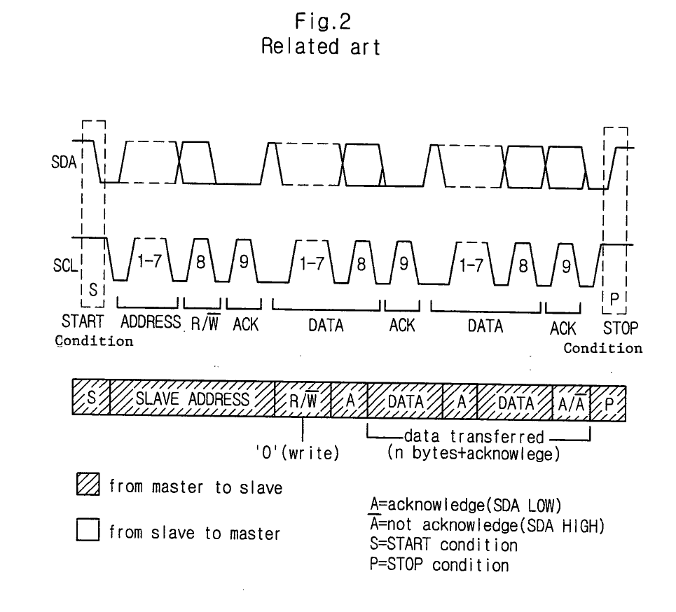

### DETAILED DESCRIPTION OF PREFERRED EMBODIMENTS

Embodiments of apparatus and methods for sharing a power line and a data communication line according to the present invention will be described with reference to the accompanying drawings.

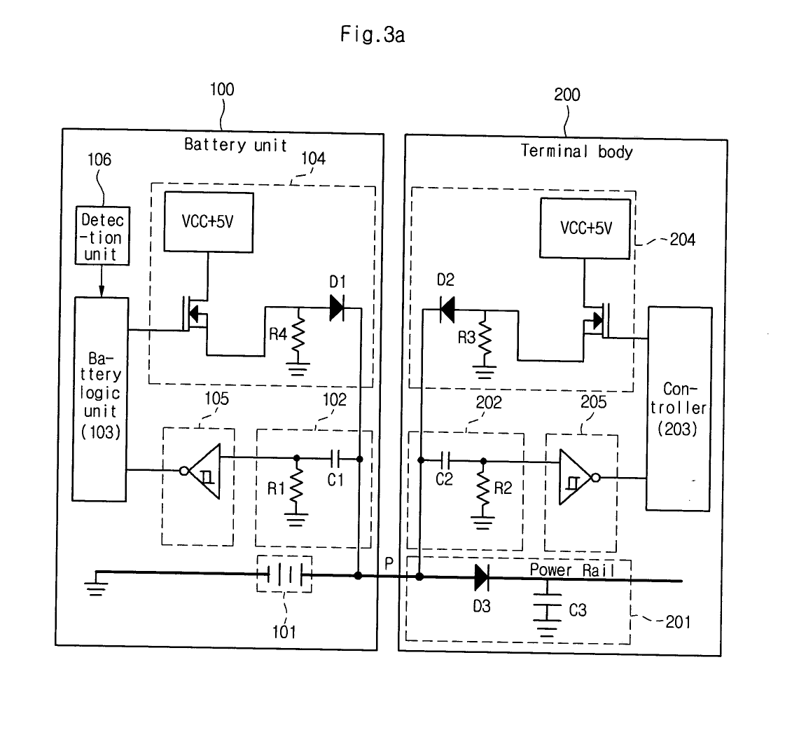

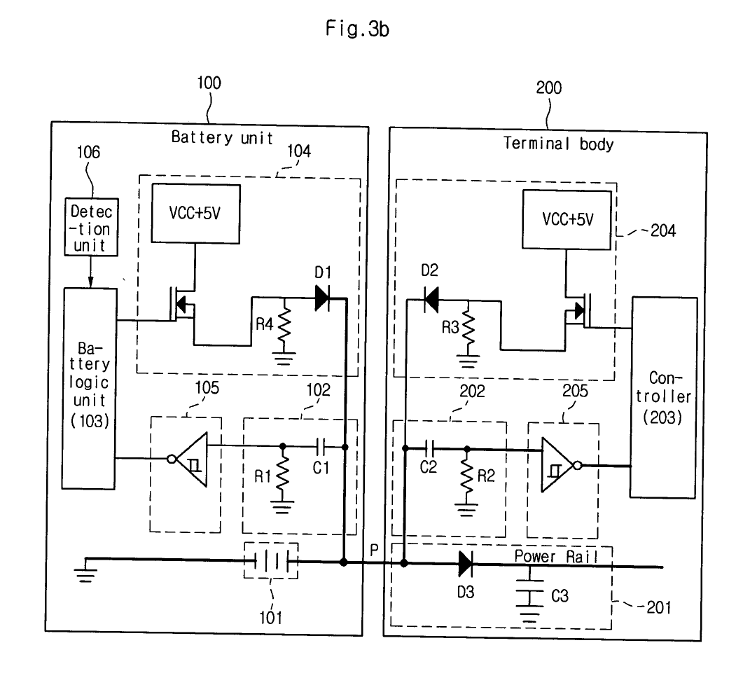

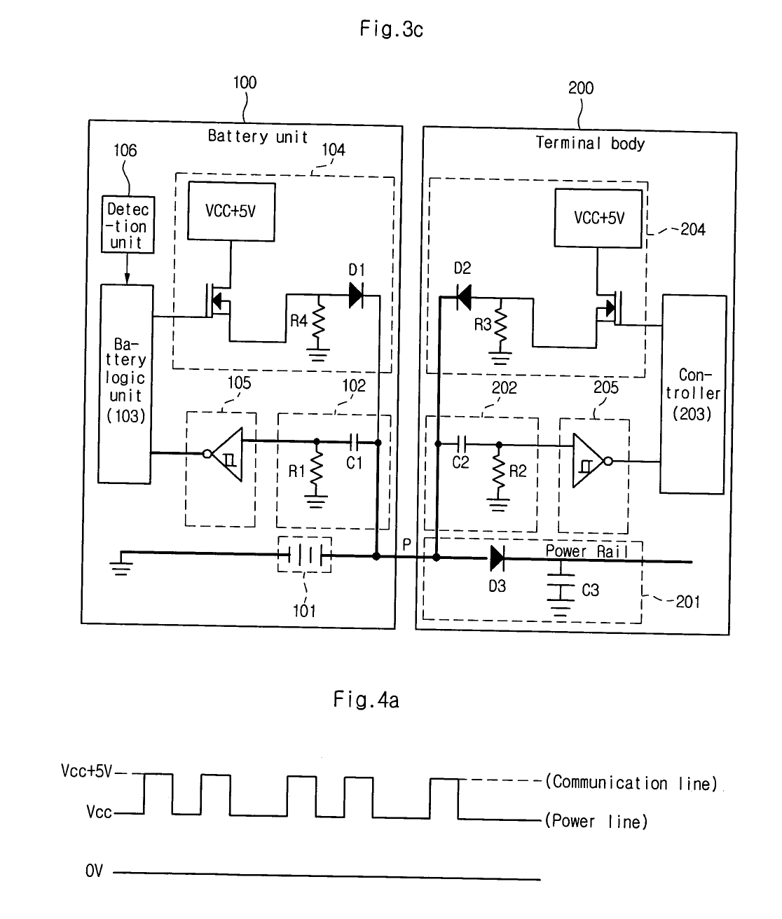

FIG. 3A is a diagram illustrating a power supply line that supplies a battery power to a terminal body according to an embodiment of the present invention. FIG. 3B is a diagram illustrating a data communication line that transfers a certain data of a battery unit to a terminal body according to an embodiment of the present invention. FIG. 3C is a diagram illustrating a data communication line that transfers a data from a terminal body to a battery unit according to an embodiment of the present invention.

As shown in FIGS. 3A-3C, a battery unit 100 can include a battery communication unit that supplies a battery data through a power line adapted to supply a battery power to a terminal body 200 and receives a communication data from the body 200. A body communication unit in the body 200 can transfer a communication data to the battery communication unit through the power line and receives the battery data.

The battery communication unit can include a battery logic unit 103, a detection unit 106, an encoding unit 104, a battery communication data separation unit 102 and a decoding unit 105. The battery logic unit 103 can receive a signal from the detection unit 106, which is configured to detect, for example, an installation state of a charged or discharged battery, a capacity of a battery and a charged or discharged state of a battery, and generate a current state data of a battery. The encoding unit 104 can convert a data generated by the battery logic unit 103 into a certain communication protocol signal for a transmission to the terminal body. The battery communication data separation unit 102 can separate and receive a communication data from a power line P, and the decoding unit 105 that can decode a communication data from the terminal body 200. At least one battery 101 can be included in the battery unit 100.

The battery communication data separation unit 102 can include a high pass filter formed of a resistor R1 and a condenser C1 configured to filter for separating a power signal in match with a communication data transferred through the power line P. In addition, the high pass filter adapted to the battery communication data separation unit 102 can perform a filtering so that an output power of the charged or discharged battery 101 formed of a low frequency is not applied to the decoding unit 105.

The high pass filter adapted to the battery communication data separation unit 102 can perform a matching operation so that a frequency of a communication protocol frequency applied from the body 200 to the battery unit 100 through the power line P is converted into a preset frequency pass band. Accordingly, a communication data from the body 200 can be separated from the power of a battery and is applied to the decoding unit 105.

The encoding unit 104 can convert a battery data from the battery logic unit 103 into a preset communication protocol signal and for application to the power line P for a transmission to the body 200.

The body communication unit can include a body encoding unit 204 that can transfer a communication data encoded into a certain or selected communication protocol signal format to the power line P, a body communication data separation unit 202 that can separate a battery data from the power line P from the power and receive the signal, and a body decoding unit 205. The body decoding unit 205 can receive a battery data from the body communication data separation unit 202 and decode the signal received.

The body encoding unit 204 can encode a communication data from a controller 203 based on a preset communication protocol. The encoded communication data can be applied to the power line P.

The body communication data separation unit 202 can separate the battery data applied to the power line P from the power. The battery data separated by the body communication data separation unit 202 can be applied to the body decoding unit 205.

Embodiments of the present invention can provide a prescribed (e.g., high pass) filter that separates the battery data from the power based on matching with the battery data transferred through the power line P. However, the present invention is not intended to be so limited.

As shown in FIGS. 3A-3C, the body communication data separation unit 202 can decouple or prevent a charge power with a selected (e.g., low) frequency from being applied to the body decoding unit 205. Preferably, a high frequency battery data transferred from the battery unit 100 can be separated from the power and applied to the body decoding unit 205.

In the exemplary high pass filter adapted to the body communication data separation unit 202, the resistor R2 and condenser C2 have a preset pass band, so that the communication data from the body encoding unit 204 is not applied to the body decoding unit 205. Therefore, the power applied from the battery unit 100 to the body 200 can be applied to a power rail through an exemplary low pass filter 201, and a communication data can be respectively applied to the power line P through the body communication data separation unit 202 and the battery communication data separation unit 102. Thus, it is possible to decrease the signal lines or contact points between the body and the battery communication units according to embodiments of the invention.

As described above, exemplary filters are described, for example, for the body communication data separation unit 202 and the battery communication data separation unit 102. However, the present invention is not intended to be so limited as other circuits or filters (e.g., band pass filters or the like) can be used to provide a data separation function selected or corresponding to a portable terminal such as a PDA, web pad, laptop, portable computer or the like.

As described above, the embodiment of FIGS. 3A-3C illustrates separate battery logic unit 103. However, the present invention is not intended to be so limited as other exemplary implementations can be used. For example, the function of the battery logic unit 103 can be included in a separate controller circuit or combined with one or more of the detection logic 106, encoding unit 104, the decoding unit 105 and battery communication data separation unit 102. Further, various combinations of the functions of the battery communication unit can be combined into a single controller or circuit. Similar combinations or allocations of functions can be provided in the body communication unit according to embodiments of the present invention.

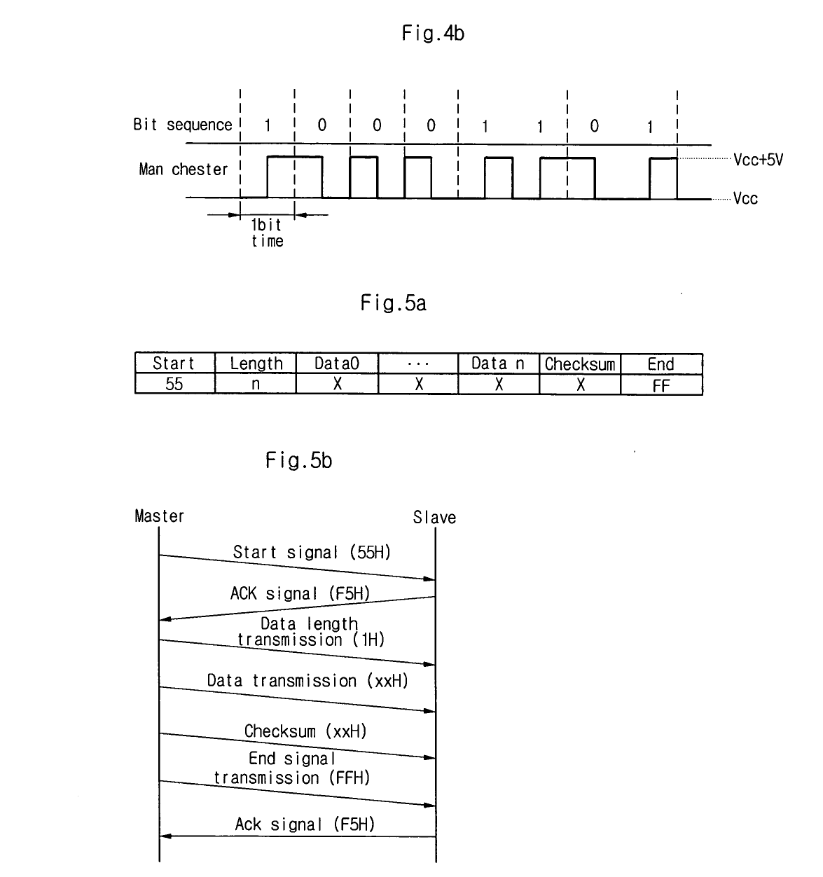

FIG. 4A is a diagram showing an exemplary waveform representing Vcc+5V for a Vcc battery power supplied to a body through a power line and a data communication between a body and a battery according to embodiments of the present invention.

As shown in FIG. 4A, the voltage 5V can be applied from the battery 101 to the body through the power line P. In addition, the data transmission and receiving between the body and the battery unit can be achieved through the battery and body separation units 102 and 202 based on the AC voltage that encodes Vcc+5V.

FIG. 4B is a diagram showing an exemplary communication protocol adapted to a power line communication apparatus according to an embodiment of the present invention. As shown in FIGS. 3A-3C and 4A, the encoding unit 104 of the battery communication unit and the body encoding unit 204 can convert the output of the data into a preset communication protocol format, and the battery data and body communication data can be respectively transferred to the power line P. The communication protocol is preferably called a Manchester encoding for the high pass filter.

The exemplary waveform and communication protocol shown in FIGS. 4A-4B can be applied to and will be described using the apparatus shown in FIGS. 3A-3C. However, embodiments of the present invention are not intended to be limited thereby because other known communication protocols can be used according to embodiments of the present invention.

As shown in FIG. 4B, in the Manchester encoding, the value of 0 can be used assuming that a high state (e.g., value 1) is maintained in a first bit section, and the high state is changed to a low state (e.g., value 0) in a subsequent or rear bit section. The value of 1 can be used assuming that a low state (e.g., value 0) is maintained in a first bit section, and the low state is changed to a high state (e.g., value 1) in a second or rear section.

In embodiments of the present invention, a preset communication protocol frequency used during a data transmission and receiving between the body 200 and the battery unit 100 can be different because it is a principle that the communication frequencies are set different for preventing or reducing a data interference or providing a data separation since the data are bi-directionally transmitted and received through one line (e.g., power or signal line). The frequency bandwidth of a preset communication protocol transferred from the body encoding 204 is preferably different from the frequency bandwidth of a preset communication protocol transferred from the battery encoding unit 104.

For example, when a communication data from the body encoding unit 204, for example, the signal of the Manchester encoding signal is a data state check signal (AAH) of 1 byte, when the signal is applied to the battery communication data separation unit 102 through the power line P, the signal could also be transferred to the body decoding unit 205 with a frequency bandwidth of the body communication data separation unit 202.

Namely, the frequency from the body encoding unit 204 can be set different from a frequency bandwidth passing through the body communication data separation unit 202 and can be matched with a preset frequency bandwidth of the battery communication data separation unit 102. Accordingly, in this example, the AAH signal is applied to the decoding unit 105 of the battery communication unit.

The battery communication unit can prevent a start signal 55H/data transmission signal xxH/end signal FFH with a Manchester encoding signal format from being applied to the decoding unit 105 based on a frequency bandwidth difference of the battery communication data separation unit 102 through the battery encoding unit 104. In addition, the battery communication unit can allow a match with a preset frequency bandwidth of the body communication data separation unit 202. The start signal 55H/data transmission signal xxH/end signal FFH are applied to the body decoding unit 205 through the body communication data separation unit 202 and are decoded by the body decoding unit 205.

FIG. 5A is a diagram showing a data format for a data transmission and receiving between a master of a body and a slave of a battery unit according to an embodiment of the present invention. FIG. 5B is a flow chart of an exemplary data transmission and receiving procedure based on the communication packet of FIG. 5A.

Operations of the flow chart of FIG. 5B will be described as follows:

1. The data transmission can be started in response to a start signal 55H.

2. The master can check whether a data is periodically inputted from the slave (AAH).

3. When a packet is received from the master, the slave response thereto can be an ACK signal (F5H).

4. The number of data to be preferably transmitted is preferably transferred to the start portion of the packet.

5. The check sum can be used for Error detection.

6. The end of the data can be formed using an end signal FFH.

7. When the data is transmitted and received, a timer can be operated, and when a time-out is detected, a data transmission and receiving is failed.

8. When transmission is failed, it is tried again. When the transmission is failed again (e.g., twice), it can be processed as the communication is failed.

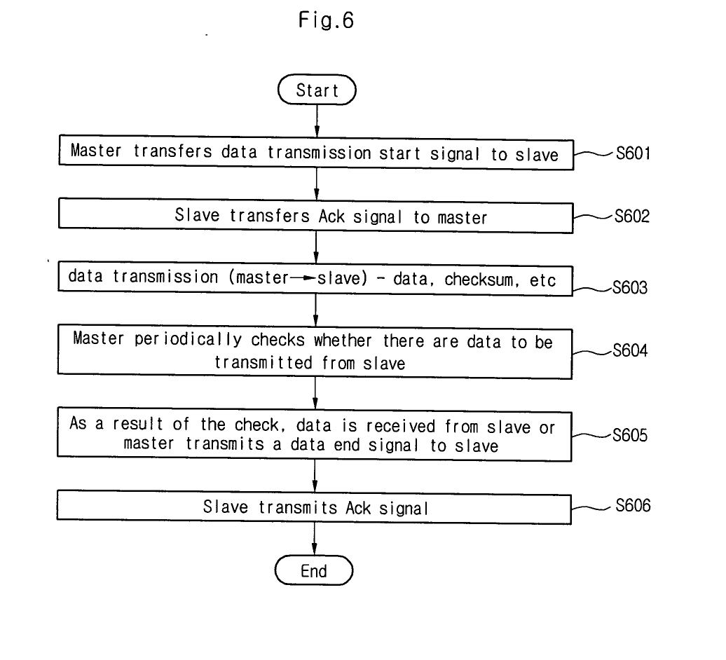

FIG. 6 is a flow chart showing a data transmission and receiving procedure between a master of a body and a slave of a battery unit according to an embodiment the present invention. As shown in FIG. 6, the embodiment of a data transmission and receiving procedure can be applied to the apparatus shown in FIGS. 3A-3C. However, the present invention is not intended to be so limited.

As shown in FIG. 6, after a process starts, a master can transmit a data transmission start signal to a slave (block S601). The slave can transmit an ACK signal to the master (block S602).

The data transmission and receiving can be performed between the master and the slave, and the master periodically checks whether there are data to be transmitted from the slave to the master (block S604). As a result of the check, when there are data to be transmitted from the slave to the master, the master receives a data from the slave (block S605). As a result of the check, when there are no data to be transmitted from the slave to the master, it is checked whether there are data to be transmitted from the master to the slave. The data from the master to the slave can be sent first (block S603). When all data are transmitted, the data end signal can be transmitted (block S605). The slave preferably transmits an ACK signal to the master responsive to the data end signal (block S606). From block S606, the process can be ended.

As described above, embodiments are directed to two-way data communications using a power line. However, the present invention is not intended to be so limited as other communications, for example, one-way communications can be provided over the power line. Further, such data communications over the power line can be provided during a charging or discharging function/operations/condition of the battery unit 100 or the terminal body 200. In addition, the power rail can include an adaptor or the like, which can include charger logic that can be used in battery charging operations.

As shown in FIG. 4A, data is provided by using a 5 Volt signal supplementing the VCC power voltage. However, the present invention is not intended to be so limited as other data or information can be provided in addition to the power on a single communication line, input/output port or pin by encoding a measurable detectable signal (e.g., voltage) with the power. Further, a single power line has been shown although a plurality of power lines can incorporate data communications, respectively.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

As described above, embodiments of the present invention have various advantages. Embodiments of the present invention relate to an apparatus and method configured to achieve a data transmission and receiving operation using one line between a body (e.g., master) and a battery unit (e.g., slave). Embodiments according to the present invention can be adapted to a communication apparatus between a master and a slave in a portable terminal such as a PDA, notebook computer, etc. and other apparatuses. Further, embodiments can achieve a data communication apparatus and method through a power signal without using a signal line adapted for a communication between a battery and a body. In addition, it is possible to decrease or eliminate a connection terminal used in a signal line between a battery and a body and to reduce or prevent an error operation because of interference between signals or a short circuit/disconnection.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1. An apparatus, comprising:
a battery communication unit configured to supply a battery data and power through a power line to a portable terminal body and receive communication data from the terminal body through the power line; and
a body communication unit configured to transmit the communication data to the battery communication unit and receive the battery data from the battery communication unit through the power line.

2. The apparatus of claim 1, wherein said battery communication unit comprises a battery communication data separation unit configured to receive and separate the communication data received through the power line.

3. The apparatus of claim 1, wherein said battery communication unit comprises a battery logic unit configured to provide and control coding of the battery data, and control decoding of the communication data according to a communication protocol.

4. The apparatus of claim 1, wherein said battery communication unit comprises:
a battery encoding unit configured to transfer the battery data encoded in a communication protocol signal format to the power line;
a battery controller configured to control the battery encoding unit to encode the battery data according to current battery status and the communication protocol;
a battery communication data separation unit configured to separate the communication data received though the power line; and
a battery decoding unit configured to decode the separated communication data received from the battery communication data separation unit.

5. The apparatus of claim 4, wherein said battery communication data separation unit is a filter matched to the communication data transferred through the power line that is capable of separating the communication data.

6. The apparatus of claim 5, wherein the filter is a high pass filter.

7. The apparatus of claim 1, wherein said battery communication unit comprises a battery logic unit configured to control coding of the battery data, and wherein the battery logic unit is configured to separate then control decoding of the communication data according to a communication protocol.

8. The apparatus of claim 1, wherein said body communication unit comprises:
a body encoding unit configured to transmit the communication data encoded in a communication protocol signal format to the power line;
a body communication data separation unit configured to apply the communication data to the power line and decouple the battery data received through the power line from the power; and
a body decoding unit configured to decode the battery data received from the body communication data separation unit.

9. The apparatus of claim 8, comprising a terminal controller configured to control the body encoding unit to encode the communication data according to the communication protocol.

10. The apparatus of claim 8, wherein said body communication data separation unit is a filter matched to the battery data transferred through the power line that is capable of separating the battery data from power.

11. The apparatus of claim 10, wherein the filter is a high pass filter.

12. The apparatus of claim 1, wherein the battery communication unit is configured to supply the battery data and battery discharge power through the power line to the portable terminal body.

13. The apparatus of claim 1, wherein the portable terminal body is configured to supply battery charge power through the power line to at least one battery in the battery communication unit.

14. A method for supplying power to a portable terminal, comprising:
providing a power line through which battery power is coupled to the portable terminal;
transmitting a battery data to the portable terminal through the power line; and
transmitting communication data from the portable terminal through the power line.

15. The method of claim 14, comprising:
transferring the battery data according to a current battery status encoded in a communication protocol signal format to the power line;
separating the communication data received through the power line; and
decoding the separated communication data.

16. The method of claim 15, wherein the separating comprises decoupling the communication data from the power provided through the power line.

17. The method of claim 16, wherein the decoupling comprises filtering the communication data using corresponding filtering characteristics matched to the encoded communication data.

18. The method of claim 14, comprising:
transferring the communication data encoded in a communication protocol signal format to the power line;
separating the battery data received through the power line;
decoding the separated battery data.

19. The method of claim 18, comprising providing battery charging power from the portable terminal to the power line.

20. A method for using a communication line to transfer power and data communications between a battery and a terminal body comprising:
providing a communication line for coupling a battery and a portable terminal body; and
transmitting a battery data and power through the communication line.

21. A method for using a communication line to transfer power and data communications between a battery and a terminal body comprising:
providing a communication line for connection between a battery and a portable terminal body; and
transmitting terminal communication data and power through the communication line.

22. An apparatus for sharing a power and data communication line in a portable terminal that is configured to supply a charge power of a battery to a terminal body, the apparatus comprising:
battery communication means for supplying battery data through a single power line through which a discharge power is supplied to the terminal body and for receiving a communication data from the terminal body through the power line; and
body communication means for transmitting the communication data to the battery communication means through the single power line and for receiving the battery data from the battery communication means through the power line.
